(19) United States
(12) Patent Application Publication
(10) Pub. No.: US 2016/0151705 A1
(43) Pub. Date: Jun. 2, 2016

(54) SYSTEM FOR PROVIDING AUGMENTED REALITY CONTENT BY USING TOY ATTACHMENT TYPE ADD-ON APPARATUS

(71) Applicant: Seung Hwan JI, Seoul (KR)

(72) Inventor: Seung Hwan JI, Seoul (KR)

(21) Appl. No.: 14/903,808

(22) PCT Filed: Jul. 8, 2014
(86) PCT No.: PCT/KR2014/006104

§ 371 Date: Jan. 8, 2016

(30) Foreign Application Priority Data
Jul. 8, 2013 (KR) 10-2013-0079452
Jul. 8, 2013 (KR) 10-2013-0079453
Jul. 8, 2013 (KR) 10-2013-0079454

(51) Int. Cl. A63F 13/24; G06F 3/0346; A63F 13/211; A63F 13/23; A63F 13/825; G06F 3/01; A63F 13/79

(52) U.S. Cl. CPC A63F 13/24; G06F 3/011; G06F 3/0346; A63F 13/79; A63F 13/23; A63F 13/825; A63F 13/211

(57) ABSTRACT

Provided is a system of providing augmented reality contents using a toy attachable add-on device. When a user couples an add-on device including a sensor and a communication unit to a toy having identification information and then performs various play activities, an image is captured by a camera to be displayed on a screen, and contents corresponding to the identification information of the toy are withdrawn to be overlaid on the screen. In this case, contents display method is appropriately selected using information on the operation state of the toy and a value detected by a built-in sensor of the add-on device. Contents corresponding to toys can be displayed through augmented reality, only by simply coupling an add-on device to various toys. Thus, a user can enjoy augmented reality contents while performing play activities using various toys.

### TECHNICAL FIELD

The present invention disclosed herein relates to an augmented reality technology field.

### BACKGROUND ART

Augmented reality refers to a technology of overlapping various kinds of information on actual videos or photographs when the actual videos and photographs taken by a camera are displayed.

It is known that the augmented reality technology was first applied to military industry as Head-Up Displays (HUDs) for a pilot, which overlay various kinds of information on objects seen by a pilot.

This augmented reality technology is receiving attention as a form of Location Based Service (LBS) due to the distribution of smart phones in recent years.

Particularly, the augmented reality technology is being combined with various business models interworking with off-line activities of a user.

Meanwhile, the augmented reality technology may also be applied to play or game products aiming at children or teenagers.

In this aspect, U.S. Pat. No. 8,384,668 entitled “Portable gaming device and gaming system combining both physical and virtual play elements” discloses a technology of displaying various effects on a screen by recognizing RFID tags when a user taps magic wand including an RFID reader on the RFID tags attached on various actual objects.

This technology enables a user to have various pleasant experiences by expressing interaction results between the magic wand and actual objects through augmented reality.

During the game activities, children recognize various goods, and move around while holding them in their hand. However, the above technology supports only extremely limited game activities in which a user taps objects on which RFID tags are attached with the magic wand, and there is a limitation in that the game activities of children using various kinds of toys cannot be sufficiently expressed through augmented reality.

That is, augmented reality is difficult to extensively utilize for various toys for children. Also, there is another limitation in that the above technology cannot deal with various activities except tapping with the magic wand.

### DISCLOSURE

### Technical Problem

Accordingly, the present disclosure provides an apparatus and method of providing augmented reality contents using a toy attachable add-on device, which can display contents corresponding to toys through augmented reality, by photographing game activities of children when children simply attach an add-on device on an existing toy and performing various motions for game.

The present disclosure also provides a platform, which can provide augmented reality contents corresponding to various toys when children play game using various existing toys.

The present disclosure also provides a platform, which is provided through augmented reality by determining a method of displaying appropriate contents with respect to various activities of children using toys.

The present disclosure also provides a method of enabling children to perform various game activities while interworking with each other using their own toys attached with an add-on device through augmented reality from a remote place.

### Technical Solution

In one general aspect, a system of providing augmented reality contents using a toy attachable add-on device includes:

a display unit for displaying graphic contents;

a contents storing unit for storing a plurality of contents corresponding to identification information for each toy and having various display methods;

a communication unit for communicating with an add-on device attached to the toy by wired/wireless communication methods;

a controller withdrawing contents corresponding to identification information of the toy, identification information of the add-on device, or a combination thereof from the contents storing unit and displaying the contents through the display unit when receiving, from the add-on device attached to the toy, the identification information read from the toy by the add-on device or the identification information of the add-on device; and

a network adapter establishing a communication session with a remote device through a network, receiving data of an image displayed on a display unit of the remote device, and receiving, from the remote device, at least one of identification information of a toy attached with a remote add-on device read out by the remote add-on device communicating with the remote device, the slope, movement direction, acceleration, relative location based on a remote camera installed toward the remote add-one device, and identification information of the remote add-on device which are received by the remote device,

wherein: when the controller receives at least one of the slope, movement direction, acceleration, relative location based on a camera toward the add-on device of the add-on device which the add-on device reads through a built-in sensor from the add-on device attached to the toy in accordance with the motion of the toy by a user, the controller determines a display method of the withdrawn contents corresponding to the identification information of the toy using the at least one;

the controller further displays the image displayed on the display unit of the remote device received through the network adapter on one side of a screen;

the controller determines an interaction between the toy and the remote toy using at least one of the identification information of the remote toy attached with the remote add-on device, the slope, movement direction, acceleration, or the remote camera-based relative location of the remote add-on device and the identification information of the remote add-one device which are received through the network adapter and at least one of the slope, movement direction, acceleration or camera-based relative location of the add-on device attached to the toy and the identification information of the add-on device; and

The display method of contents may be determined using the determined interaction.

In another general aspect, a system of providing augmented reality contents using a toy attachable add-on device includes:

a display unit for displaying graphic contents;

a contents storing unit for storing a plurality of contents corresponding to identification information for each toy and having various display methods;

a communication unit for communicating with an add-on device attached to the toy by wired/wireless communication methods; and

a controller withdrawing contents corresponding to identification information of the toy, identification information of the add-on device, or a combination thereof from the contents storing unit and displaying the contents through the display unit when receiving, from the add-on device attached to the toy, the identification information read from the toy by the add-on device or the identification information of the add-on device,

wherein:

when the controller receives at least one of the slope, movement direction, acceleration, relative location based on a camera toward the add-on device of the add-on device which the add-on device reads through a built-in sensor from the add-on device attached to the toy in accordance with the motion of the toy by a user, the controller determines a display method of the withdrawn contents corresponding to the identification information of the toy using the at least one;

In another general aspect, a toy attachable augmented reality controller coupled to a toy including identification information includes an add-on device including:

an add-on housing;

a communication unit mounted in the add-on housing and communicating with an augmented reality contents providing device by a wired/wireless communication method;

a sensor mounted in the add-on housing and detecting at least one of gravity, acceleration, slope and movement direction which are applied to the add-on housing; and

a control circuit unit reading out the identification information of the toy from the toy as the add-on housing is coupled to the toy and transmitting the identification information of the toy to the augmented reality contents providing device through the communication unit in addition to a value detected by the sensor.

In this case, the control circuit unit may reads out identification information of the add-on device, and may further transmit the identification information of the add-on device to the augmented reality contents providing device instead of or in addition to the identification information of the toy.

Meanwhile, the control circuit unit may check information on a part to which the toy is coupled among a plurality of coupling parts of the add-on housing to which the toy is coupled, and

the control circuit unit may read out the identification information of the toy coupled to the corresponding part and may transmits a combination of the information on the coupling part and the identification information of the toy to the augmented reality contents providing device.

Meanwhile, the control circuit unit may acquire information on a part where the add-on housing is coupled to the toy from the toy as the add-on housing is coupled to the toy, and may further transmit the information on the coupling part to the toy attachable augmented reality controller.

In another general aspect, a toy attachable augmented reality controller includes:

a toy including:

a toy housing;

an identification information storing unit mounted in the toy housing and storing identification information of the toy that is digital data;

an add-on seating part recessed from an outer side of the toy housing and allowing at least a portion of the add-on housing to be inserted into and coupled to the recessed space of the toy housing; and

a connector including a terminal exposed inside the add-on seating part and electrically connecting a connection terminal of the add-on housing and the identification information storing unit as the add-on housing is coupled to the add-on seating part, and

an add-on device including:

an add-on housing;

a communication unit mounted in the add-on housing and communicating with a remote device by a wired/wireless communication method;

a sensor mounted in the add-on housing and detecting at least one of gravity, acceleration, slope and movement direction which are applied to the add-on housing; and

a control circuit unit reading out the identification information of the toy from the identification information storing unit of the toy as the add-on housing is coupled to the add-on seating part of the toy and transmitting the identification information of the toy and a value detected by the sensor to the remote device through the communication unit.

A toy attachable augmented reality controller including a toy coupled to an add-on device including: an add-on housing; a communication unit mounted in the add-on housing and communicating with a remote device by a wired/wireless communication method; a sensor mounted in the add-on housing and detecting at least one of gravity, acceleration, slope and movement direction which are applied to the add-on housing; and a control circuit unit reading out the identification information of the toy from the identification information storing unit of the toy as the add-on housing is coupled to the add-on seating part of the toy and transmitting the identification information of the toy and a value detected by the sensor to the remote device through the communication unit,

wherein the toy includes:

a toy housing;

an identification information storing unit mounted in the toy housing and storing identification information of the toy that is digital data; and

an add-on seating part recessed from an outer side of the toy housing and allowing at least a portion of the add-on housing to be inserted into and coupled to the recessed space of the toy housing; and

The toy attachable augmented reality controller of claim 19, wherein the toy further includes a connector including a terminal exposed inside the add-on seating part and electrically connecting a connection terminal of the add-on housing and the identification information storing unit as the add-on housing is coupled to the add-on seating part.

A toy attachable augmented reality controller including a toy coupled to an add-on device including: an add-on housing; a communication unit mounted in the add-on housing and communicating with a remote device by a wired/wireless communication method; a sensor mounted in the add-on housing and detecting at least one of gravity, acceleration, slope and movement direction which are applied to the add-on housing; a plurality of switches exposed on one side surface of the add-on housing and generating a signal when being pressed or contacted; and a control circuit unit transmitting a value detected by the sensor to the remote device through the communication unit, wherein when the add-on housing is coupled to the add-on seating part of the toy, at least a portion of the plurality of switches is pressed or contacted by a switch trigger of the toy, and the control circuit unit transmits information on a combination of switches generating a signal among the plurality of switches to the remote device through the communication unit,

wherein the toy includes:

a toy housing;

an add-on seating part recessed from an outer side of the toy housing and allowing at least a portion of the add-on housing to be inserted into and coupled to the recessed space of the toy housing; and

at least one switch trigger protruded or recessed at one side of the add-on seating part.

Other features and aspects will be apparent from the following detailed description, the drawings, and the claims.

### Advantageous Effects

According to embodiments of the present invention, contents corresponding to toys can be displayed through augmented reality, only by simply coupling an add-on device to various toys.

Accordingly, a user can enjoy play using various toys with only one or two add-on devices.

In addition, when a user performs various motions or activities with a toy, augmented reality contents corresponding to each motion or activity can be provided.

Furthermore, a user can perform various play activities while interacting with each other with his/her own toy to which an add-on device is attached, by connecting two or more users through a network.

Meanwhile, in terms of economic effect, since a platform provided by the present invention serves as a medium which connects a toy, an add-on device and contents, contents providers can make profits only by developing augmented reality contents for each type of toys and registering the platform provided by the present invention as augmented reality users who use toys increase.

Also, since toy manufacturers can manufacture toys corresponding to augmented reality only by manufacturing toys including a unit for attaching and detaching an add-on device and identification information, an increase of cost can be minimized, and development of a new product group is possible.

### DESCRIPTION OF DRAWINGS

FIG. 1 is a view illustrating an exterior and relationship of a toy and an add-on device.

FIG. 2 is a view illustrating a user performing game activities using a toy coupled with an add-on device through augmented reality.

FIG. 3 is a view illustrating a connection relationship of an augmented reality contents providing system, a toy, an add-on device, and a server according to an embodiment of the present invention.

FIG. 4 is a block diagram illustrating components of a augmented reality contents providing system according to an embodiment of the present invention.

FIG. 5 is a view illustrating an example of augmented reality contents for a multi-user using an augmented reality contents providing system of a remote place.

FIG. 6 is a view illustrating an exterior of a toy attachable augmented reality controller according to an embodiment of the present invention.

FIG. 7 is a block diagram illustrating components of a toy attachable augmented reality controller according to an embodiment of the present invention.

FIG. 8 is a view illustrating a plurality of add-on devices coupled to a toy.

### BEST MODE

Hereinafter, exemplary embodiments of the present invention will be described in detail with reference to the accompanying drawings. In order to clarify the present invention, a description irrelevant to the constitution of the present invention will be omitted, and in the drawings, like reference numerals refer to like elements throughout.

Meanwhile, since the terms “including”, “including”, and “having” can be construed as encompassing corresponding components unless specially described as opposite, it should be understood that they do not exclude other components but encompass other components.

In the detailed description of the invention and claims, components named as “˜unit”, “˜part”, “˜module”, and “˜block” mean units that process at least one function or operation, and each of which can be implemented by software, hardware, or a combination thereof.

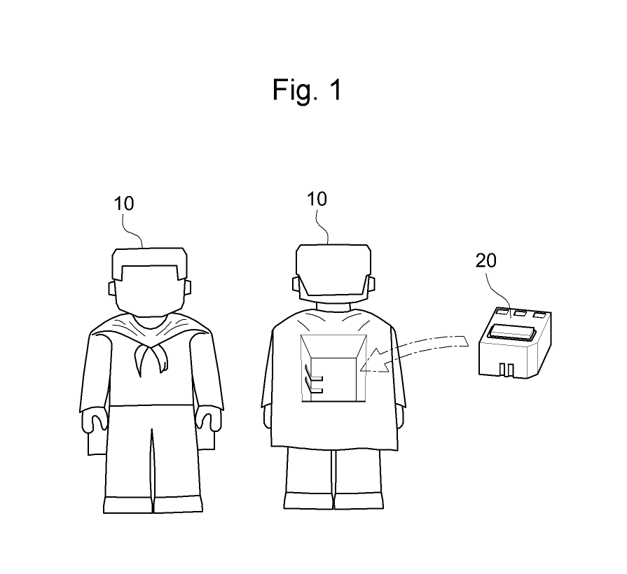

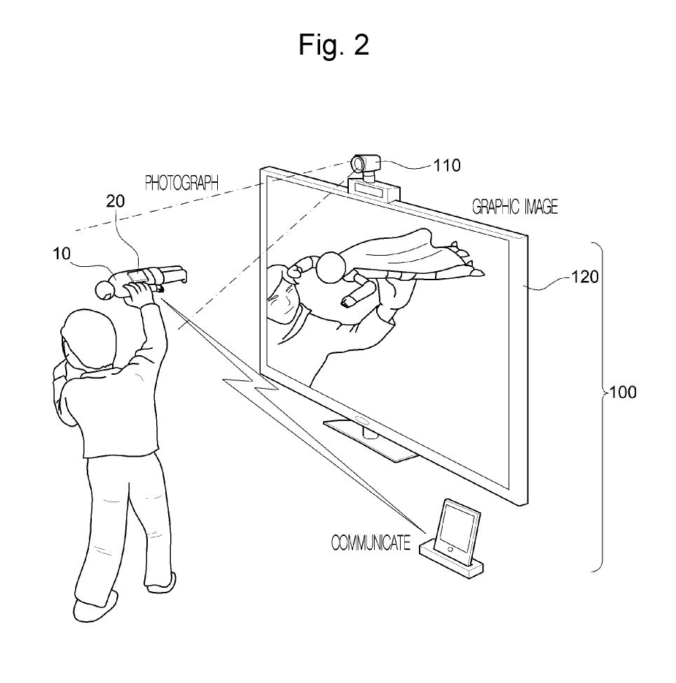

First, an augmented reality contents providing system according to an embodiment of the present invention will be generally described with reference to FIGS. 1 and 2.

FIG. 1 is a view illustrating the concept and relationship of a toy and an add-on device.

As shown in FIG. 1, a toy 10 may have a space in which an add-on device 20 can be seated.

The toy 10 may be a plaything used by children and teenagers for game activities, and may have identification information.

Meanwhile, the add-on device 20 may include various sensors for sensing motion, e.g., a gravity sensor and an acceleration sensor, and may be coupled to the toy 10 to read the identification information of the toy 10.

The add-on device 20 may communicate with an augmented reality contents providing system 100 by known wired/wireless communication methods such as Bluetooth and WiFi. The identification information of the toy 10 and the value sensed by sensors may be provided for the augmented reality contents providing system 100. If necessary, the add-on device 20 may also provide its own identification information for the augmented reality contents providing system 100.

The augmented reality contents providing system 100 may include a camera and a display unit.

As shown in FIG. 2, the augmented reality contents providing system 100 may display an image of a user photographed by the camera on a screen, and in this case, may overlay prepared graphic images on the location of the toy 10.

The augmented reality contents providing system 100 may check the location of the add-on device 20. In this case, a Radio Frequency (RF) communication may be used, or an image recognition technology may be additionally used to check the location of the add-on device 20. The technology for this may be selected from one of technologies that are already developed in the augmented reality technology field.

The augmented reality contents providing system 100 may withdraw contents from a plurality of pre-registered contents in accordance with the identification information of the toy 10 provided from the add-on device 20.

Also, contents may separately exist in each toy 10.

For example, trains appearing on TV program “Thomas & Friends” for kids may be provided with contents related to the corresponding train, respectively.

That is, the toys 10 corresponding to each train may be on the market, and each toy 10 may include identification information for representing the kinds or motion types of the corresponding toys or uniquely identifying the corresponding toys. Also, the augmented reality contents providing system 100 may withdraw appropriate contents from contents related to a plurality of pre-registered trains using the identification information of the corresponding toy.

Contents may be graphic images taking the shape of trains, and may be an animation in which smoke rises from the smokestack of a train, a sound occurring during the running of a train, or a caption displaying the dialogue of trains. The types or forms of contents will not be limited.

In the above example, although contents have been illustrated as the form of simple multimedia contents, as generally provided in the augmented reality technology field, game contents or various types of contents which are provided by a method of combining events of on-line/off-line may be applied.

In addition, content may also be determined in accordance with the identification information of the add-on device 20, or may also be determined in accordance with a combination of the identification information of the toy 10 and the identification information of the add-on device 20.

In case where contents take the form of game, even though the identification information of the toy 10 and the identification information of the add-on device 20 are identical to each other, different contents may also be withdrawn in accordance with the scenario or the progress of a game.

Meanwhile, the augmented reality contents providing system 100 may determine an area where contents are to be displayed, from the location of the add-on device which is checked based on a photographed image.

For example, when the photographed image is a graphic image taking the shape of a train, the augmented reality contents providing system 100 may determine a certain area except a background centering around the location of the add-on device 20 through an image analysis, as an area of the toy 10 where the graphic image is to be displayed.

Also, when the photographed image is an animation taking the shape of smoke coming from the smokestack of a train, the augmented reality contents providing system 100 may determine the location on the screen where the corresponding contents are to be displayed, using the relative location (e.g., preset information that the add-on device 20 is fixedly coupled to a location downwardly away from the center of the toy 10 by about 10 cm, and the smokestack exists at a location of left-top away from the center of the toy 10 by about 15 cm) of the toy 10 and the add-on device 20 which can be known from the identification information of the corresponding toy 10, or can be acquired from the add-on device 20.

Thereafter, withdrawn contents may be displayed on the screen.

FIG. 2 illustrates augmented reality contents displayed through the above process.

A user may fixedly couple the add-on device 20 to one side of the toy 10, and then may perform play activities of various motions with the toy 10.

The play activity of a user may be captured by a camera, and may be displayed on a display unit.

Meanwhile, contents corresponding to the identification information of the corresponding toy 10 may be withdrawn and overlaid on the location of the toy 10 displayed on the display unit.

The identification information that the toy includes may be a unique identifier including a simple combination of numerals or characters, which is identically designated for the same type of toys, but may be data having a hierarchical structure.

For example, the identification information may also have layers such as data representing the type of toys-unique identifier of corresponding toy-data representing the motion type of toys.

The types of toys may be roughly divided into infant toys, children's toys, and teenager's toys, and the children's toys may be again divided into human-like toys, vehicle-like toys, airplane-like toys, and spaceship-like toys.

The human-like toys may be again divided into dolls, tokusatsu heroes, robot type 1, and robot type 2.

That is, data representing the type may have layers in itself.

For example, the data representing the type may be classified into a form of tree structure.

Thus, since all toys cannot be provided with contents, classifying of type may be to find a toy type closest to the corresponding toy and allow the toy type to be substituted for contents of the corresponding toy which does not have contents.

When contents for a specific toy are not prepared, a toy which is prepared with contents and is closest to the specific toy may be found in accordance with the tree structure, and the corresponding contents may be substituted for the contents of the specific toy.

For example, assume that a user purchases a Taekwon V toy pertaining to “children's toy-human-like toy-robot type 1” and couples the add-on device 20 to the toy for use. In this case, when there are no contents corresponding to the Taekwon V toy, contents of “Mazinger” that is a robot type 1 closest to Taekwon V in the tree structure may be withdrawn and used instead.

Meanwhile, in addition to data representing the type, a separate unique identifier may be further provided.

In this case, the unique identifier may be data subordinate to the data representing the type, and may overlap that of other toy when the data representing type are different.

Meanwhile, when the toy 10 is a motion toy, the identification information may include information on the motion type of the toy.

For example, a train toy may perform two operations such as moving forward by a battery or making a train sound through a speaker.

In the above example, the identification information that the toy 10 includes may further include identification information representing the forward motion of a train and identification information corresponding to the train sound.

When the augmented reality contents providing system 100 receives information that the toy 10 performs a motion by a manipulation of a user from the add-on device 20, the augmented reality contents providing system 100 may withdraw contents corresponding to the motion, and may display the corresponding contents on the screen.

In the above example, when a user allows the train toy to make a sound by operating the train toy, the add-on device 20 may read out a signal informing that the train sound is played through the speaker from the toy 10, and may provide the signal for the augmented reality contents providing system 100.

Thus, the augmented reality contents providing system 100 may withdraw and display contents—for example, a wave file corresponding to train sound or an animation in which the train is running while making a sound—corresponding to the received signal.

The same type of toys may have similar operation patterns, and as described above, may withdraw and use contents of the closest type when contents for a specific toy are not prepared.

Meanwhile, when augmented reality contents are provided for each toy 10 of a user by the above method, a user can perform various play activities with a plurality of his/her own toys 10 as along as each toy 10 includes identification information and the add-on device 20 reads out the identification information to provide the identification information for the augmented reality contents providing system 100 even though a user purchases only one or two add-on devices 20.

Hereinafter, an environment in which augmented reality contents are provided by an augmented reality contents providing system according to an embodiment of the present invention will be described.

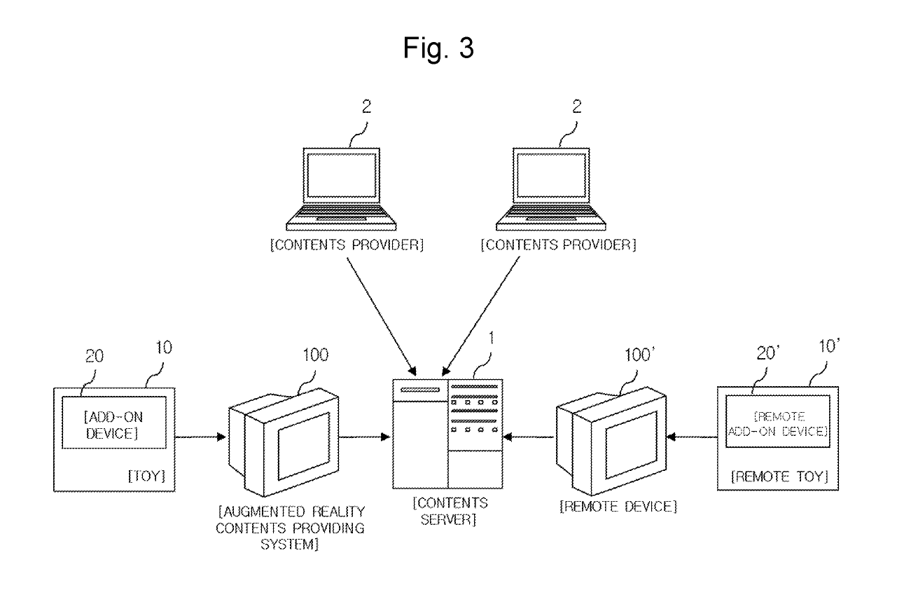

FIG. 3 is a view illustrating a connection relationship of an augmented reality contents providing system, a toy, an add-on device, and a server according to an embodiment of the present invention.

As shown in FIG. 3, the augmented reality contents providing system 100 may photograph the toy 10 and the add-on device 20 through the camera, and may communicate with the add-on device 20 as described in FIG. 2.

Meanwhile, a contents provider 2 as shown in FIG. 3 may make contents for each toy, and may upload and register the contents on a server 1.

The server 1 may store and manage contents registered from a plurality of contents providers 2 in accordance with the identification information of toys.

Contents that are uploaded and registered may be stored in accordance with hierarchical identification information like the type of the toy 10 as described above. Meanwhile, a user may purchase a plurality of toys 10 which are compatible with the add-on device 20. In order to enjoy contents through augmented reality, a user may purchase the add-on device 20 and a product (e.g., set-top box or smartphone application) which is a component of the augmented reality contents providing system 100 and communicates with the add-on device 20, and may connect the product to a computer with a monitor or a home TV.

Thereafter, the add-on device 20 may be coupled to the toy 10 as shown in FIG. 1, and then transmit the identification information of the toy 10 to the augmented reality contents providing system 100. Thus, augmented reality contents corresponding to the toy 10 (i.e., not the add-on device 20) may be provided.

If necessary, a user may move to a contents selling page provided by the server 10 through a mobile or web browser, and may additionally purchase paid contents.

A portion of contents registered in the server 10 may be provided for a user for free when a user purchases the toy 10, but another portion of contents may also be provided through the augmented reality contents providing system 100 of a user only when a user purchases and storing the contents in his/her own account.

A user may directly purchase contents related to a specific toy 10 through the mobile or web browser to store the contents in his/her account, but may also present contents to other users through a social network service.

For this, the server 10 needs to interwork with the corresponding social network service server.

The augmented reality contents providing system 100 may be connected to the server 1 through a network, and may download and store contents the purchase history of which exists in the user's account. Also, the augmented reality contents providing system 100 may download and store contents received as a present through the user's account from the server 1.

Meanwhile, as shown in FIG. 3, a user may be connected to another augmented reality contents providing system (hereinafter, referred to as remote device) 100′ at a remote place via the server 1 or directly.

A friend of a user or another user who is one of personal connections in the social network service may couple an add-on device (hereinafter, referred to remote add-on device) 20 to his/her toy (hereinafter, referred to as remote toy) 10′, and may enjoy augmented reality contents through the remote device 100′. Also, users may share augmented reality contents with each other by being connected to the augmented reality contents providing system 100 via the server 1 or directly.

For example, users connected on-line may enjoy a multimedia game which is implemented through augmented reality.

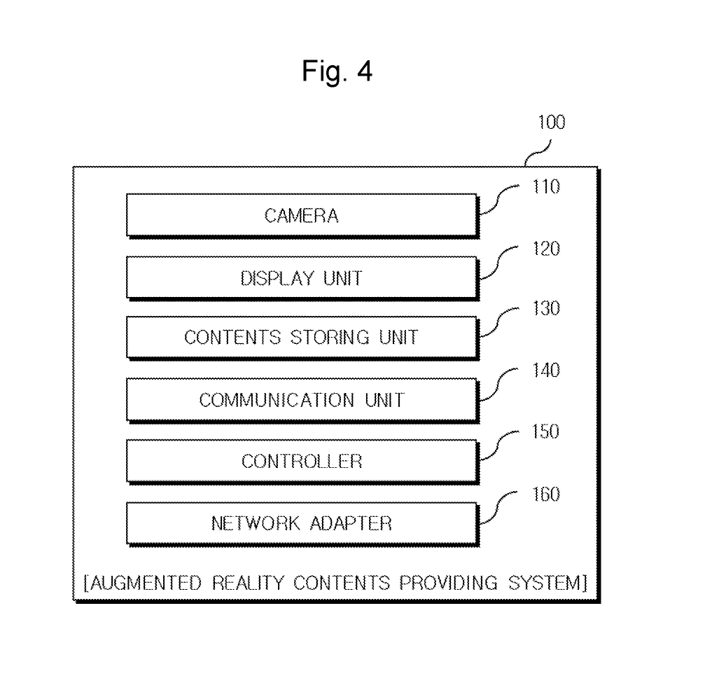

Hereinafter, the configuration of an augmented reality contents providing system using an toy attachable add-on device according to an embodiment of the present invention will be described with reference to FIG. 4.

FIG. 4 is a block diagram illustrating components of a augmented reality contents providing system according to an embodiment of the present invention.

As shown in FIG. 4, the augmented reality contents providing system 100 may include a camera 110, a display unit 120, a contents storing unit 130, a communication unit 140, a controller 150, and a network adapter 160.

The cameral 110 may correspond to a known component which is a unit for capturing an image. That is, the camera 110 may include a camera mounted in a well-known smartphone, a camera provided in a home game console, and a webcam attached on a personal computer.

The display unit 120 may display images photographed by the camera 110 and contents, and may correspond to a well-known component similarly to the camera 110.

That is, the display unit 120 may be a computer monitor, a touchscreen of a smartphone, and a home TV.

The augmented reality contents providing system 100 may be related to a device that displays images photographed through the camera 110 through the display unit 12 and overlays graphic contents on the image photographed by the camera 110.

The contents storing unit 130 may store contents downloaded from the server 1. In this case, contents may correspond to the identification information of toys.

Meanwhile, contents may be displayed in various manners.

The meaning that contents are displayed in various manners is that contents are displayed in accordance with values sensed by sensors mounted in the add-on device 20 or the operation state of the toy 10.

For example, in case of train toy, when a sensor of the add-on device 20 senses that a user moves forward the train toy, the graphic image of a train which is at a stop may be changed into a form of animation of a train which is moving, and may be displayed.

The graphic image of a train which is at a stop and the animation of a train which is moving may both belong to contents corresponding to the train toy, and may correspond to one of display manners.

The communication unit 140 may communicate with the add-on device 20 attached to the toy 10 by wired/wireless communication methods.

The communication method may include well-known communication methods such as Bluetooth, Radio Frequency (RF), and Wi-Fi.

Meanwhile, when the controller 150 receives identification information, which the add-on device 20 reads out from the toy 10, from the add-on device 20 attached to the toy 10, the controller 150 may withdraw contents corresponding to the identification information of the toy 10 from the contents storing unit 130.

Also, the controller 150 may select a display method corresponding to the motion of the toy 10 or the sensor measure value received from the add-on device 20 from the withdrawn contents, and may display contents through the display unit 120.

That is, when the controller 150 receives at least one information of slope, movement direction, acceleration, camera-based relative location of the add-on device 20 which the add-on device 20 reads through a built-in sensor from the add-on device 20 attached to the toy 10 in accordance with the motion of the toy 10 by a user, the controller 150 may determine the display method of the withdrawn contents corresponding to the identification information of the toy 10 using the at least one information.

When a user is holding the toy 10 motionlessly, a display method corresponding to a default-in the above example, graphic image of a train that is at a stop-may be selected, but the display method corresponding to the change of the sensor value of the add-on device 20 may be appropriately selected to be displayed through the display unit 120.

When the toy 10 is a motion toy and the type of motion of the toy 10 is further received through the add-on device 20, an appropriate display method may be again selected in accordance with the motion of the toy 10.

The controller 150 may determine the location on the screen of the display unit 120 where selected contents are to be displayed by the following method.

First, the controller 150 may collect relative location information based on the camera 110 of the add-on device 20. That is, the controller 150 may check a distance from the front side of the camera 110, a distance front the left or right side of the camera 110, and a vertical height. In this case, well-known techniques of use RF, IR, or infrared ray sensor may be used.

Meanwhile, the controller 150 may determine the location of the add-on device 20 attached to the toy 10 in an image photographed by the camera 110 from the relative location of the add-on device 20.

The area of the toy 10 to which the add-on device 20 is attached may be determined by extracting the contour of objects except the background through the image interpretation based on the determined location of the add-on device 20 attached to the toy 10.

That is, the background and objects may be distinguished using the focal length from the camera 110, and then the contour of the toy 10 may be traced except the hand of a user.

Thus, the selected contents may be overlaid and displayed on the location of the toy 10.

In this case, contents displayed on the screen of the display unit 120 may be three-dimensional graphic data of the toy 10.

Also, various display methods of contents may further include information on a display direction of the three-dimensional graphic data of the toy 10 and an attachment angle between the toy 10 and the add-on device 20.

For example, various display methods according to viewpoints such as three-dimensional graphic data viewed from the front side of the toy 10 and three-dimensional graphic data viewed from the side of the toy 3 may be implemented.

In addition, information may be further provided with respect to the attachment angle of the add-on device 20 to the toy 10.

For example, when viewed from the front side of the toy 10, the add-on device may be inserted at a right angle as shown in FIG. 1, and in this case, values of rotational direction or movement direction which are collected by the built-in sensor of the add-on device 20 needs to be converted into a right direction to become the rotational direction or the movement direction of the toy 10.

Accordingly, the controller 150 may obtain difference values of information on the slope sensed by the add-on device 20 and the attachment angle of the toy 10 and the add-on device 20, and may determine the display direction of the three-dimensional graphic data of the toy 10 using the difference values.

That is, when the add-on device 20 maintains level, as shown in FIG. 2, the toy 10 may be considered to lie parallel to the ground surface. Thus, the controller 150 may determine the display direction—i.e., any one of various display methods—of the three-dimensional graphic data of the toy 10.

Meanwhile, contents corresponding to the identification information of the toy 10 may include graphic data for each part of the toy 10, and may the add-on device 20 may be attached to a specific part of the toy 10.

For example, it may be assumed that the toy 10 is a robot and the graphic data for each part is a protective gear like a helmet or a weapon like guns or knives.

In this case, when the add-on device 20 is attached to the hand or arm of the toy 10, the graphic data corresponding to the gun or knife may be selected. On the other hand, when the add-on device 20 is attached to the head, graphic data corresponding to the helmet may be selected.

For this, the controller 150 may read the location of the add-on device 20 attached to the toy 10 from the image photographed by the camera 110 using the relative location information based on the camera 110 of the add-on device 20.

That is, information on the part of the toy 10 to which the add-on device 20 is attached needs to be received from the add-on device 20.

The above case may premise that a plurality of add-on devices 20 are attached to any one of toys 10.

That is, the graphic data may be differently selected in accordance with the combination or location of the add-on devices 20 attached to one toy 10.

On the contrary, the graphic data may be differently selected even in case where any one add-on device 20 is simultaneously combined with a plurality of toys 10.

That is, when a plurality of toys 10 are attached to one add-on device 20, appropriate graphic data may be selected by receiving, from the add-on device 20, the combination of identification information of each toy 10 or the location information where each toy 10 is attached to the add-on device 20.

Thus, when the location of the add-on device 20 attached to the toy 10 is read, the display unit 120 may overlay and display the withdrawn graphic data on the location of the add-on device 20 attached to the toy 10 which is read out.

The augmented reality contents providing system 100 may further include a network adapter 160 for connecting to the server 1 through the network.

The network may refer to an Internet network, and may also refer to a well-known communication networks such as LAN, WAN, intranet, mobile communication network, and LTE.

The controller 150 may access the server 1 through the network adapter 160 to check whether or not contents corresponding to the identification information of the toy 10 are additionally acquired from the user account of the add-on device attached to the toy 10.

That is, the controller 150 may check whether a user additionally purchases contents or receives a present.

When there is an additional acquisition detail, the controller 150 may download contents additionally acquired by a user from the server 10, and may upload the contents to the contents storing unit 130 for updating.

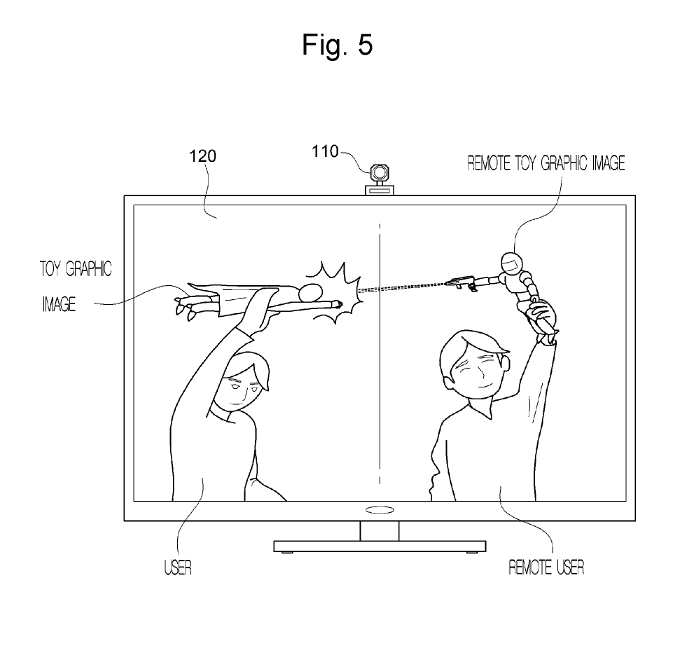

Hereinafter, the configuration of an augmented reality contents providing system using an toy attachable add-on device according to another embodiment of the present invention will be described with reference to FIG. 5.

FIG. 5 is a view illustrating an example of augmented reality contents for a multi-user using an augmented reality contents providing system of a remote place.

In this embodiment, a case where two or more users perform play activities with toys 10 to which the add-on device 20 is attached at difference remote places will be described.

According to another embodiment of the present invention, an augmented reality contents providing system 100 may establish a communication session with a remote device 100′ through a network adapter 160.

Meanwhile, the augmented reality content providing system 100 may receive data of an image on which a graphic image is overlaid and which is displayed on a display unit 120′ of the remote device 100′ from the remote device 100′.

On the contrary, the image displayed through the display unit 120 may be transmitted in real-time to the remote device 100′.

Meanwhile, the augmented reality contents providing system 100 may further receive, from the remote device 100′, at least one of identification information of the remote toy 10′ read by the remote add-on device 20′ from the remote device 100′, the slope, movement direction and acceleration of the remote add-on device 20′, and the relative location based on the remote camera 110′.

In this case, the remote device 100′ may be a augmented reality contents providing system that another user at a remote place uses, and the remote add-on device 20′ and the remote toy 10′ may indicate an add-on device and a toy which are used by another user at the remote place.

As shown in FIG. 5, the controller 150 may further display an image displayed on the display unit 120′ of the remote device 100′ received through the network adapter on one side of the screen.

Also, the interaction between the toy 10 and the remote toy 10′ may be determined using information on the slope, movement direction, acceleration or camera-based relative location of the remote device 20′ and information on the slope, movement direction, acceleration or camera-based relative location of the remote device 20 which are received through the network adapter 160.

The display method of contents may be determined using the determined interaction.

Specifically, the controller 150 may first generate coordinates on the virtual coordinate system of the toy 10 using the relative location based on the camera of the add-on device 20 attached to the toy 10.

That is, the coordinates of the whole image displayed on the screen may be set to (0.0) to (1600, 1200). This is called the virtual coordinate system.

Then, the coordinates of the toy 10 may be first set. When the toy 10 is displayed on a location around (100, 300), the coordinate of the toy 10 on the virtual coordinate system may become (100, 300).

Then, a reference location of the remote toy 10′ on the virtual coordinate system may be set.

As shown in FIG. 5, since the remote toy is displayed on the right half of the screen, an area corresponding to (800, 0) to (1600, 1200) may be assigned to the remote toy.

Then, (800, 0) may become a reference location where the remote toy 10′ is to be displayed.

Also, the coordinates of the remote toy 10′ on the virtual coordinate system may be generated using the relative location based on a remote camera 110′ of the remote add-on device 20′ which is received through the network adapter.

For example, when the remote toy 10′ on the screen of the remote device 100′ is displayed on the coordinates corresponding to (150, 150), new coordinates (950, 150) to which (150, 150) is transformed based on the reference location (800, 0) may become the coordinates of the remote toy 10′ on the virtual coordinate system.

Accordingly, the toy 10 and the remote toy 10′ may be expressed on the same coordinate system.

Thereafter, when a user performs play activities with the toy 10 or a remote user performs play activities with the remote toy 10′, the interaction between the toy 10 and the remote toy 10 may be determined using the coordinate changes of the toy 10 and the remote toy 10′ according to the play activities.

For example, the toy 10 and the remote toy 10′ may collide with each other or become close to or distant from each other on the virtual coordinate system.

Also, the controller 150 may select a display method of contents according to the interaction of the toy 10 and the remote toy 10′ when displaying contents corresponding to the identification information of the toy 10 through the display unit 120.

When the toy 10 and the remote toy 10′ collide with each other on the virtual coordinate system, graphic data processing an animation or special effect expressing collision may be selected to be displayed on the screen.

Meanwhile, the controller 150 may provide information on the interaction between the toy 10 and the remote toy 10′ determined as above for the remote device 100′ through the network adapter 160.

Meanwhile, as the interaction between the toy 10 and the remote toy 10′ is determined, the controller 150 may transmit a control command corresponding to the interaction between the toy 10 and the remote toy 10′ to the add-on device 20 through the communication unit 140.

The add-on device 20 may receive the control command, and may respond to the control command by, for example, generating a vibration through a vibration motor mounted in the add-on device 20 or generating a beep sound.

When the toy 10 is a motion toy and is manufactured so as to receive the control command through the add-on device 20, the add-on device 20 may apply the received control command to the toy 10, and thus the toy 10 may perform an operation corresponding to the control command.

### Mode for Invention

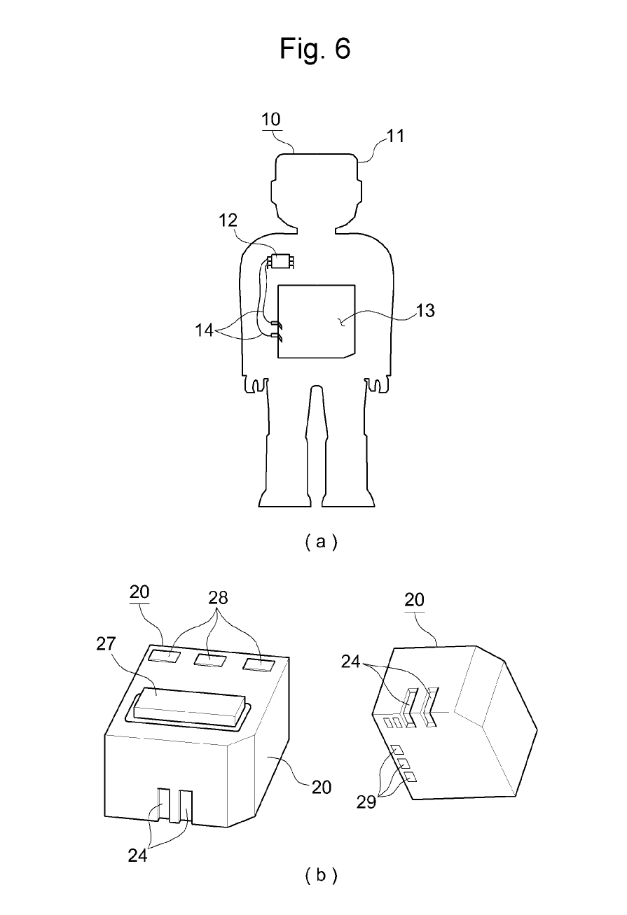

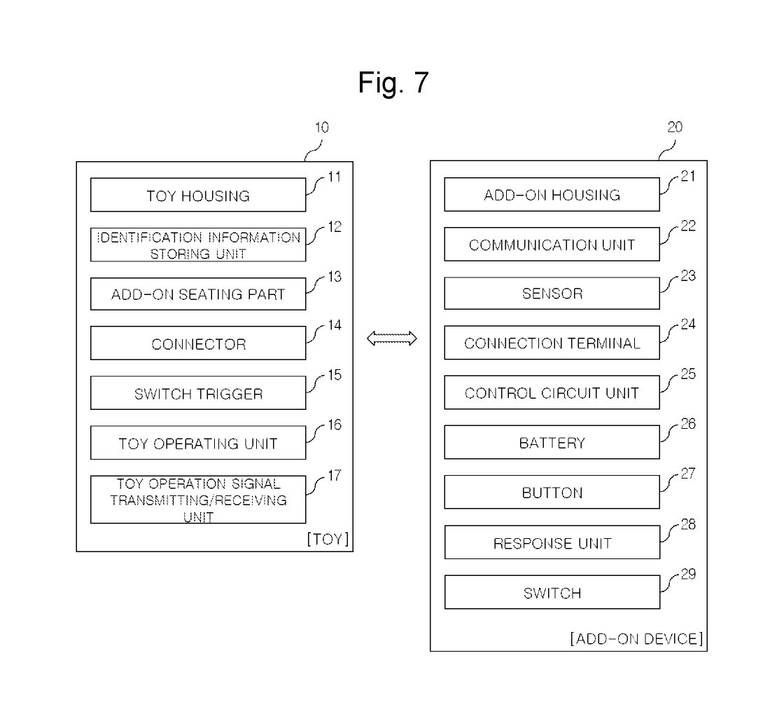

Hereinafter, the structure of a toy attachable augmented reality controller according to an embodiment of the present invention will be described in detail with reference to FIGS. 6 and 7.

The toy attachable augmented reality controller may be a combination of the toy 10 and the add-on device 20, or may correspond to the add-on device 20 coupled to the toy 10.

First, in regard to the structure of the toy 10 as shown in FIG. 7, the toy 10 may include a toy housing 11, an identification information storing unit 12, an add-on seating part 13, a connector 14, a switch trigger 15, a toy operating unit 16, and a toy operation signal transmitting/receiving unit 17.

The toy housing 11 may correspond to a well-known toy. The toy housing 11 may be formed of synthetic resin or metallic material by a method such as die casting or injection molding, and may correspond to a general toy which is assembled from two or more parts.

The identification information storing unit 12 may be mounted in the toy housing, and may store identification information of the toy 10 which is digital data.

The identification information of the toy 10, as described above, may be a unique identifier (e.g., “14213xage”) that is a combination of characters and numerals), and may also be hierarchical data (e.g., “children's toy-human-like toy-robot type 1-Taekwon V-motion type 1, motion type 2, motion type 3”) including layers such as the type of toy, the unique identifier and the type of motion.

The identification information storing unit 12 may be a well-known unit for storing digital data such as non-volatile memories or IC chips.

The add-on seating part 13 may correspond to an outer part of the toy housing 11 to which an add-on housing 21 is coupled.

As illustrated in FIG. 6, the add-on seating part 13 may be a space form in which an outer one side of the toy housing 11 is recessed and at least a portion of the add-on housing 21 is inserted and coupled.

However, if the add-on seating part 13 is coupled and combined with the add-on housing, then the add-on seating part 13 need not have a form into which a portion of the add-on housing 21 is inserted.

In this case, the add-on seating part 13, as shown in FIG. 3, may be manufactured so as to have a shape correspond to the add-on housing 21 such that the add-on housing 21 can be inserted into and coupled to the add-on seating part 13 only in a specific direction.

For coupling of the add-on housing 21, a member such as a latch may be further provided such that the add-on housing 21 is latched when the add-on housing 21 is inserted up to a certain depth,

In addition to the latch, various members such as quick release, screw, and tongs may be used as long as the add-on housing 21 can be fixedly coupled at least.

The add-on 20 may read out identification information stored in the identification information storing unit 12 of the toy 10 as the add-on 20 is coupled to the add-on seating part 13.

The connector 14 may be provided for reading of the identification information, and may include a terminal exposed inside the add-on seating part 13. The connector 14 may be electrically connected to the identification information storing unit 12.

As shown in FIG. 1, as the add-on housing 21 is coupled to the add-on seating part 13, the connector 14 may electrically connect the connection terminal of the add-on housing 21 and the identification information storing unit 12.

Thus, the add-on device 20 can read out identification information of the toy 10 which is stored in the identification information storing unit 12 as described later.

Meanwhile, in addition to the method in which the identification information is provided for the add-on device 20 by direct contact through the connector 14, a wireless local area network method such as Bluetooth may be used to transmit the identification information to the add-on device 20.

In this case, a wireless communication adapter may be provided instead of the connector 14.

As shown in FIG. 7, the add-on device 20 may include an add-on housing 21, a communication unit 22, a sensor 23, a connection terminal 24, a control circuit unit 25, a battery 26, a button 27, a response unit 28, and a plurality of switches 29.

The add-on housing 21 may have a space formed therein, and may have a shape corresponding to the add-on seating part 13 of the toy 10 at least on one side thereof.

Thus, as shown in FIG. 1, a user can couple and fix the add-on housing 21 to the add-on seating part 13 of the toy 10.

The communication unit 22 may be mounted in the add-on housing 21, and may communicate with the augmented reality contents providing device 1 by a wired/wireless communication method.

In this case, well-known wired/wireless communication methods such as Bluetooth, Radio Frequency (RF), Infrared Ray (IR) and Wi-Fi may be used.

The sensor 23 may be mounted in the add-on housing 21, and may detect at least one of gravity, acceleration, slope and movement direction which are applied to the add-on housing 21.

For this, one or more sensors 23 may be provided.

The connection terminal 24 may contact the connector 14 exposed to the inside of the add-on seating part 13 as the add-on housing 21 is inserted into the add-on seating part 13 of the toy 10.

The control circuit unit 25 may read out the identification information from the identification information storing unit 12 of the toy through the connection terminal 24.

However, as described above, the identification information of the toy 10 may be read out from the toy by a wireless communication method, and in this case, a wireless communication adapter may also be used instead of the connection terminal 24.

The control circuit unit 25 may transmit the identification information of the toy and values detected by the sensor 23 for the augmented reality contents providing device 1 through the communication unit 22.

Thus, as shown in FIG. 2, the augmented reality contents providing device 1 may withdraw contents corresponding to the identification information of the toy 10, and may display the contents through the display unit.

In this case, the control circuit unit 25 may further store the identification information of the add-on device 20, and may provide the identification information of the add-on device 20 for the augmented reality contents providing device 1 instead of or in addition to the identification information of the toy 10.

Also, the augmented reality contents providing device 1 may withdraw appropriate contents in accordance with the identification information of the add-on device 20 or a combination of the identification information of the toy 10 and the add-on device 20.

The augmented reality contents providing device 1 may variously modify and display contents in accordance with the values detected by the sensor 23.

For example, when a user moves forward while holding a train toy, the sensor 23 may detect the movement direction, speed, and acceleration. The augmented reality contents providing device 1 may display a caption “too fast, be careful” in accordance with the detected values, or may play a wave file corresponding to a fast moving train sound or an animation including a special effect such as a fast moving train.

Meanwhile, when the toy 10 is a motion toy, more various play activities can be performed.

In this case, the toy 10 may include at least one of a motor, a speaker and a light emitting unit, and may further include a toy operating unit 16 that controls the motion of the toy 10 through the motor, the speaker, or the light emitting unit (e.g., LED), generates a sound, or emits light.

The toy operating unit 16 may correspond to a member provided in a well-known motion toy for operation (including generation of a sound and emission of light) of the toy.

The toy 10 may further include a toy operation signal transmitting/receiving unit 17 that transmits a toy operation signal indicating the type of toy motion to the add-on device 20 coupled to the add-on seating part 13 when the toy 10 is operated by the toy operating unit 16—that is, when the toy moves by a motor or a sound is generated through the speaker, or light is emitted through the light emitting unit.

In the example of train toy, the train toy may perform two motions “motion type 1” that is moving forward, and “motion type 2” that is playing train sound.

The toy operation signal transmitting/receiving unit 17 may provide the add-on device 20 with a “motion type 1” signal when the train toy moves forward, and a “motion type 2” signal when the train sound is played.

Meanwhile, when the control circuit unit 25 of the add-on device 20 receives a toy operation signal informing the type of toy motion through the connection terminal 24, the control circuit unit 25 may transmit the received toy operation signal to the augmented reality contents providing device 1 through the communication unit 22.

Thus, the augmented reality contents providing device 1 may further display contents corresponding to the toy motion on the screen of the display unit using the toy operation signal.

On the other hand, when a certain event occurs in contents provided by the augmented reality contents providing device 1-for example, when a train collides with an obstacle in game contents using a train toy, the augmented reality contents providing device 1 may transmit a control command to the add-on device 20, more specifically, the communication unit 22 of the add-on device 20.

When the toy 10 is a motion toy and the motion types (e.g., “motion type 1” and “motion type 2”) of the corresponding toy 10 can be seen in advance from the identification information of the corresponding toy 10, the control command may be a signal corresponding to any one of motions that the toy 10 can perform.

When the control circuit unit 25 receives the control command for controlling the motion of the toy 10 from the augmented reality contents providing device 1 in a state where the add-on housing 21 is coupled to the add-on seating part 13 of the toy 10, the control circuit unit 25 may provide the control command for the toy operation signal transmitting/receiving unit 17 of the toy through the connection terminal 24.

The toy operation signal transmitting/receiving unit 17 of the toy 10 may control the toy operating unit 16 in accordance with the received control command so as to perform a certain motion.

In the example of train toy, when a control signal of “motion type 1” is received, the motor of the toy operating unit 16 may be controlled such that the train toy moves forward. Also, when a control signal of “motion type 2” is received, the train sound may be played through the speaker.

Meanwhile, when the toy 10 is not a motion toy or when the toy 10 is not a motion toy that is operated by a remote controller, the add-on device 20 may be also allowed to respond to the control command from the augmented reality contents providing device 1.

In this case, the add-on device 20 may include at least one of a vibration motor, a speaker and a light emitting unit, and may include a response unit 28 that generates vibration through the vibration motor, or generates a sound through the speaker, or emits light through the light emitting unit.

Meanwhile, when the control circuit unit 25 receives from the control command from the augmented reality contents providing device 1, the control circuit unit 25 may control the response unit 28 to generate vibration, sound or light.

In the example of train toy, when a control signal of “motion type 1” is received, the control circuit unit 23 may control the vibration motor of the response unit 28 to generate vibration, or when a control signal of “motion type 2” is received, a beep sound may be generated through the speaker of the response unit 28.

Although prepared motions for each toy cannot be accurately performed, it may be possible to respond to the control command from the augmented reality contents providing device 1 through at least elements such as vibration, sound, light emitting of LED.

In the above example, when the toy performs motion, the control circuit unit 23 may inform the augmented reality contents providing device of the motion type of the toy 10, and according thereto, the augmented reality contents providing device may display appropriate contents through the display unit.

However, when it is difficult to read out the motion type of the toy with an electrical signal-when this function is not provided for the toy 10 itself, a certain input unit may be provided for the add-on device 20.

For example, the add-on device 20 may further include a button 27 exposed to the outside of the add-on housing 21. The button 27 may be provided in plurality.

Meanwhile, when a user presses the button 27, the control circuit unit 25 may transmit a button press event signal informing the button 27 is pressed to the augmented reality contents providing device 1 through the communication unit 22.

Thus, the augmented reality contents providing device may select and display appropriate contents from contents corresponding to the identification information of the toy 10 in accordance with the pressed button.

In the example of train toy, when a user presses one of two buttons, the augmented reality contents providing device 1 may consider that a signal of “motion type 1” of “train toy” having a specific unique identifier is inputted, and may display a moving forward train animation on the display screen.

That is, although the toy 10 does not operate, the button press event signal may be mapped into the “motion type 1” signal of the corresponding toy, and thus a response may be generated as if the train toy moves forward.

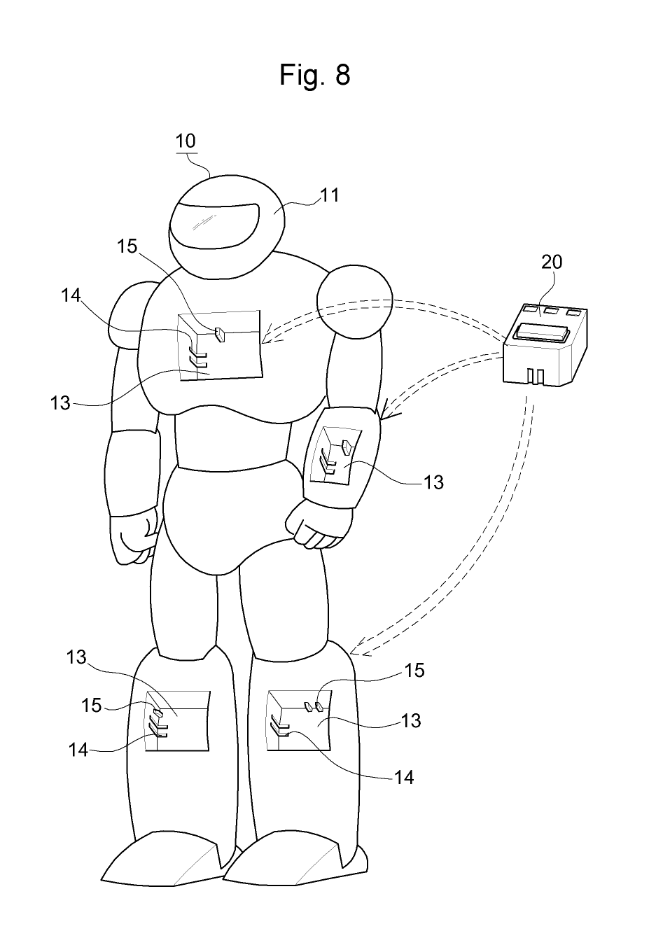

Hereinafter, a toy attachable augmented reality controller according to another embodiment of the present invention will be described in detail with reference to FIG. 8.

FIG. 8 is a view illustrating a plurality of add-on devices coupled to a toy.

As shown in FIG. 8, at least one switch trigger 15 that is protruded or recessed may be further provided on one side of the add-on seating part 13 provided for the toy 10.

The at least one switch trigger 15 may represent the identification information of the toy 10 or the coupling part of the toy 10 by their location and combination.

Meanwhile, a plurality of switches 29 may be provided and exposed on one side surface of the add-on housing 21 of the add-on device 20.

The plurality of switches 29 may generate a signal by being pressed or contacted.

As shown in FIG. 8, when a user couples the add-on device 20, i.e., the add-on housing 21 to the add-on seating part 13 of the toy 10, at least a portion of the plurality of switches 29 may be pressed by the switch trigger 15 or make contact with the switch trigger 15 of the toy 10.

Thus, when switches 29 pressed by the switch trigger 15 or making contact with the switch trigger 15 may generate a signal, the control circuit unit 25 may transmit information on a combination of the switches 29 generating the signal to the augmented reality contents providing device 1 through the communication unit 22.

As shown in FIG. 8, the switch trigger 15 may have a protruding step shape. When the add-on housing 21 is coupled to the add-on seating part 13 of the toy 10, one of the plurality of switches 29 may be pressed.

On the other hand, the switch trigger 15 may have a recessed shape. In this case, when the add-on housing 21 is coupled to the add-on seating part 13 of the toy 10, switches 29 other than the switches 29 facing the switch trigger 15 may be pressed by the bottom surface of the add-on seating part 13

Thus, the toy 10 can be identified by the combination of the switches 29 that are pressed.

Also, as shown in the previous embodiment, the identification information that is digital data may be stored by the identification information storing unit, and separately, a combination of the switches 29 that are pressed may also be utilized.

For example, four add-on seating parts 13 may be provided in FIG. 8.

Meanwhile, the add-on seating part 13 and the add-on device 20 may be provided so as to be coupled to each other only in a specific direction, and at least one switch trigger 15 provided in the add-on seating part 13 may differ from each other in a combination of their location or number.

That is, when a user couples the add-on device 20 to the add-on seating part 13, a combination of the switches 29 that are pressed may differ for each add-on seating part 13.

Thus, when the add-on device 20 is coupled to any one of the add-on seating parts 13 provided in the toy 10, the control circuit unit 25 may transmit information on a combination of pressed switches 29 to the augmented reality contents providing 1 through the communication unit 22.

Accordingly, the augmented reality contents providing device 1 may identify the part of toy 10 to which the add-on device 20 is coupled to.

In this case, the control circuit unit 25 may combine at least one of values detected by the sensor 23, the identification information of the toy 10, information on the part coupled with the toy 10, and the identification information of the add-on device 20 to transmit to the augmented reality contents providing device 1.

That is, when the augmented reality contents providing device 1 communicates with two or more add-on devices 20 at the same time, the augmented reality contents providing device 1 may select appropriate contents from the combination of transmitted information, and may identify which add-on device 20 the signal is transmitted from, by the combination of transmitted information.

Also, contents corresponding to the identification information of the corresponding toy 10, particularly, contents regarding the part to which the add-on device 20 is coupled may be withdrawn to be displayed through the display unit.

For example, when the add-on device 20 is attached to the arm of a robot toy as shown in FIG. 8, the augmented reality contents providing device 1 may overlay and display a graphic image of a weapon such as a knife or a gun around the arm part of the robot toy image displayed on the screen.

In this case, when the button 27 of the add-on device 20 is pressed, an animation of swinging a knife or shooting a gun may be played.

On the other hand, when the add-on device 20 is coupled to the body or leg, appropriate contents related to the corresponding part may be similarly withdrawn to be displayed on the screen of the display unit.

In the above description, although the add-on device 20 is illustrated as an electronic device including the communication unit 22 and the sensor 23 and the toy 10 is illustrated as a tool used when a user performs play activities, in an actual embodiment, these may not be clearly distinguished at least in terms of appearance.

That is, the add-on device 20 may also be a toy or a form of plaything, and the toy 10 may be another plaything.

For example, the toy 10 may be a robot toy, and the add-on device 20 may be manufactured into a form of weapon or gear that is attachable to the robot toy.

Meanwhile, in the above example, although a plurality of add-on devices 20 are illustrated as being coupled to one toy 10, on the contrary, a plurality of toys 20 may be coupled to one add-on device 20.

In this case, the add-on device 20 may include a plurality of coupling parts to which the toy 10 can be coupled, and a coupling part to which the toy 10 is coupled may be checked. In this case, a combination with the identification information of the toy 10 coupled to the corresponding part may be transmitted to the augmented reality contents providing device 1.

The augmented reality contents providing device 1 may withdraw appropriate contents using a combination thereof similarly to a case where a plurality of add-on devices 20 are coupled to one toy 10.

Hereinafter, the structure of a toy to which an augmented reality controller according to an embodiment of the present invention is attached will be described in detail with reference to FIGS. 6 and 7.

The toy to which the augmented reality controller is attached may be a combination of the toy 10 and the add-on device 20, or may correspond to the add-on device 20 coupled to the toy 10.

First, in regard to the structure of the toy 10 as shown in FIG. 7, the toy 10 may include a toy housing 11, an identification information storing unit 12, an add-on seating part 13, a connector 14, a switch trigger 15, a toy operating unit 16, and a toy operation signal transmitting/receiving unit 17.

The toy housing 11 may correspond to a well-known toy. The toy housing 11 may be formed of synthetic resin or metallic material by a method such as die casting or injection molding, and may correspond to a general toy which is assembled from two or more parts.

The identification information storing unit 12 may be mounted in the toy housing, and may store identification information of the toy 10 which is digital data.

The identification information of the toy 10, as described above, may be a unique identifier (e.g., “14213xage”) that is a combination of characters and numerals), and may also be hierarchical data (e.g., “children's toy-human-like toy-robot type 1-Taekwon V-motion type 1, motion type 2, motion type 3”) including layers such as the type of toy, the unique identifier and the type of motion.

The identification information storing unit 12 may be a well-known unit for storing digital data such as non-volatile memories or IC chips.

The add-on seating part 13 may correspond to an outer part of the toy housing 11 to which an add-on housing 21 is coupled.

As illustrated in FIG. 6, the add-on seating part 13 may be a space form in which an outer one side of the toy housing 11 is recessed and at least a portion of the add-on housing 21 is inserted and coupled.

However, if the add-on seating part 13 is coupled and combined with the add-on housing, then the add-on seating part 13 need not have a form into which a portion of the add-on housing 21 is inserted.

In this case, the add-on seating part 13, as shown in FIG. 3, may be manufactured so as to have a shape correspond to the add-on housing 21 such that the add-on housing 21 can be inserted into and coupled to the add-on seating part 13 only in a specific direction.

For coupling of the add-on housing 21, a member such as a latch may be further provided such that the add-on housing 21 is latched when the add-on housing 21 is inserted up to a certain depth,

In addition to the latch, various members such as quick release, screw, and tongs may be used as long as the add-on housing 21 can be fixedly coupled at least.

The add-on 20 may read out identification information stored in the identification information storing unit 12 of the toy 10 as the add-on 20 is coupled to the add-on seating part 13.

The connector 14 may be provided for reading of the identification information, and may include a terminal exposed inside the add-on seating part 13. The connector 14 may be electrically connected to the identification information storing unit 12.

As shown in FIG. 1, as the add-on housing 21 is coupled to the add-on seating part 13, the connector 14 may electrically connect the connection terminal of the add-on housing 21 and the identification information storing unit 12.

Thus, the add-on device 20 can read out identification information of the toy 10 which is stored in the identification information storing unit 12 as described later.

Meanwhile, in addition to the method in which the identification information is provided for the add-on device 20 by direct contact through the connector 14, a wireless local area network method such as Bluetooth may be used to transmit the identification information to the add-on device 20.

In this case, a wireless communication adapter may be provided instead of the connector 14.

As shown in FIG. 7, the add-on device 20 may include an add-on housing 21, a communication unit 22, a sensor 23, a connection terminal 24, a control circuit unit 25, a battery 26, a button 27, a response unit 28, and a plurality of switches 29.

The add-on housing 21 may have a space formed therein, and may have a shape corresponding to the add-on seating part 13 of the toy 10 at least on one side thereof.

Thus, as shown in FIG. 1, a user can couple and fix the add-on housing 21 to the add-on seating part 13 of the toy 10.

The communication unit 22 may be mounted in the add-on housing 21, and may communicate with the augmented reality contents providing device 1 by a wired/wireless communication method.

In this case, well-known wired/wireless communication methods such as Bluetooth, Radio Frequency (RF), Infrared Ray (IR) and Wi-Fi may be used.

The sensor 23 may be mounted in the add-on housing 21, and may detect at least one of gravity, acceleration, slope and movement direction which are applied to the add-on housing 21.

For this, one or more sensors 23 may be provided.

The connection terminal 24 may contact the connector 14 exposed to the inside of the add-on seating part 13 as the add-on housing 21 is inserted into the add-on seating part 13 of the toy 10.

The control circuit unit 25 may read out the identification information from the identification information storing unit 12 of the toy through the connection terminal 24.

However, as described above, the identification information of the toy 10 may be read out from the toy by a wireless communication method, and in this case, a wireless communication adapter may also be used instead of the connection terminal 24.

The control circuit unit 25 may transmit the identification information of the toy and values detected by the sensor 23 for the augmented reality contents providing device 1 through the communication unit 22.

Thus, as shown in FIG. 2, the augmented reality contents providing device 1 may withdraw contents corresponding to the identification information of the toy 10, and may display the contents through the display unit.

The augmented reality contents providing device 1 may variously modify and display contents in accordance with the values detected by the sensor 23.

For example, when a user moves forward while holding a train toy, the sensor 23 may detect the movement direction, speed, and acceleration. The augmented reality contents providing device 1 may display a caption “too fast, be careful” in accordance with the detected values, or may play a wave file corresponding to a fast moving train sound or an animation including a special effect such as a fast moving train.

Meanwhile, when the toy 10 is a motion toy, more various play activities can be performed.

In this case, the toy 10 may include at least one of a motor, a speaker and a light emitting unit, and may further include a toy operating unit 16 that controls the motion of the toy 10 through the motor, the speaker, or the light emitting unit (e.g., LED), generates a sound, or emits light.

The toy operating unit 16 may correspond to a member provided in a well-known motion toy for operation (including generation of a sound and emission of light) of the toy.

The toy 10 may further include a toy operation signal transmitting/receiving unit 17 that transmits a toy operation signal indicating the type of toy motion to the add-on device 20 coupled to the add-on seating part 13 when the toy 10 is operated by the toy operating unit 16—that is, when the toy moves by a motor or a sound is generated through the speaker, or light is emitted through the light emitting unit.

In the example of train toy, the train toy may perform two motions “motion type 1” that is moving forward, and “motion type 2” that is playing train sound.

The toy operation signal transmitting/receiving unit 17 may provide the add-on device 20 with a “motion type 1” signal when the train toy moves forward, and a “motion type 2” signal when the train sound is played.

Meanwhile, when the control circuit unit 25 of the add-on device 20 receives a toy operation signal informing the type of toy motion through the connection terminal 24, the control circuit unit 25 may transmit the received toy operation signal to the augmented reality contents providing device 1 through the communication unit 22.

Thus, the augmented reality contents providing device 1 may further display contents corresponding to the toy motion on the screen of the display unit using the toy operation signal.

On the other hand, when a certain event occurs in contents provided by the augmented reality contents providing device 1—for example, when a train collides with an obstacle in game contents using a train toy, the augmented reality contents providing device 1 may transmit a control command to the add-on device 20, more specifically, the communication unit 22 of the add-on device 20.

When the toy 10 is a motion toy and the motion types (e.g., “motion type 1” and “motion type 2”) of the corresponding toy 10 can be seen in advance from the identification information of the corresponding toy 10, the control command may be a signal corresponding to any one of motions that the toy 10 can perform.

When the control circuit unit 25 receives the control command for controlling the motion of the toy 10 from the augmented reality contents providing device 1 in a state where the add-on housing 21 is coupled to the add-on seating part 13 of the toy 10, the control circuit unit 25 may provide the control command for the toy operation signal transmitting/receiving unit 17 of the toy through the connection terminal 24.

The toy operation signal transmitting/receiving unit 17 of the toy 10 may control the toy operating unit 16 in accordance with the received control command so as to perform a certain motion.

In the example of train toy, when a control signal of “motion type 1” is received, the motor of the toy operating unit 16 may be controlled such that the train toy moves forward. Also, when a control signal of “motion type 2” is received, the train sound may be played through the speaker.

Meanwhile, when the toy 10 is not a motion toy or when the toy 10 is not a motion toy that is operated by a remote controller, the add-on device 20 may be also allowed to respond to the control command from the augmented reality contents providing device 1.

In this case, the add-on device 20 may include at least one of a vibration motor, a speaker and a light emitting unit, and may include a response unit 28 that generates vibration through the vibration motor, or generates a sound through the speaker, or emits light through the light emitting unit.

Meanwhile, when the control circuit unit 25 receives from the control command from the augmented reality contents providing device 1, the control circuit unit 25 may control the response unit 28 to generate vibration, sound or light.

In the example of train toy, when a control signal of “motion type 1” is received, the control circuit unit 23 may control the vibration motor of the response unit 28 to generate vibration, or when a control signal of “motion type 2” is received, a beep sound may be generated through the speaker of the response unit 28.

Although prepared motions for each toy cannot be accurately performed, it may be possible to respond to the control command from the augmented reality contents providing device 1 through at least elements such as vibration, sound, light emitting of LED.

In the above example, when the toy performs motion, the control circuit unit 23 may inform the augmented reality contents providing device of the motion type of the toy 10, and according thereto, the augmented reality contents providing device may display appropriate contents through the display unit.

However, when it is difficult to read out the motion type of the toy with an electrical signal-when this function is not provided for the toy 10 itself, a certain input unit may be provided for the add-on device 20.

For example, the add-on device 20 may further include a button 27 exposed to the outside of the add-on housing 21. The button 27 may be provided in plurality.

Meanwhile, when a user presses the button 27, the control circuit unit 25 may transmit a button press event signal informing the button 27 is pressed to the augmented reality contents providing device 1 through the communication unit 22.

Thus, the augmented reality contents providing device may select and display appropriate contents from contents corresponding to the identification information of the toy 10 in accordance with the pressed button.

In the example of train toy, when a user presses one of two buttons, the augmented reality contents providing device 1 may consider that a signal of “motion type 1” of “train toy” having a specific unique identifier is inputted, and may display a moving forward train animation on the display screen.

That is, although the toy 10 does not operate, the button press event signal may be mapped into the “motion type 1” signal of the corresponding toy, and thus a response may be generated as if the train toy moves forward.

Hereinafter, a toy to which an augmented reality controller according to another embodiment of the present invention will be described in detail with reference to FIG. 8.

FIG. 8 is a view illustrating a plurality of add-on devices coupled to a toy.

As shown in FIG. 8, at least one switch trigger 15 that is protruded or recessed may be further provided on one side of the add-on seating part 13 provided for the toy 10.

The at least one switch trigger 15 may represent the identification information of the toy 10 by their location and combination.

Meanwhile, a plurality of switches 29 may be provided and exposed on one side surface of the add-on housing 21 of the add-on device 20.

The plurality of switches 29 may generate a signal by being pressed or contacted.

As shown in FIG. 8, when a user couples the add-on device 20, i.e., the add-on housing 21 to the add-on seating part 13 of the toy 10, at least a portion of the plurality of switches 29 may be pressed by the switch trigger 15 or make contact with the switch trigger 15 of the toy 10.

Thus, when switches 29 pressed by the switch trigger 15 or making contact with the switch trigger 15 may generate a signal, the control circuit unit 25 may transmit information on a combination of the switches 29 generating the signal to the augmented reality contents providing device 1 through the communication unit 22.

As shown in FIG. 8, the switch trigger 15 may have a protruding step shape. When the add-on housing 21 is coupled to the add-on seating part 13 of the toy 10, one of the plurality of switches 29 may be pressed.

On the other hand, the switch trigger 15 may have a recessed shape. In this case, when the add-on housing 21 is coupled to the add-on seating part 13 of the toy 10, switches 29 other than the switches 29 facing the switch trigger 15 may be pressed by the bottom surface of the add-on seating part 13

Thus, the toy 10 can be identified by the combination of the switches 29 that are pressed.

Also, as shown in the previous embodiment, the identification information that is digital data may be stored by the identification information storing unit, and separately, a combination of the switches 29 that are pressed may also be utilized.

For example, four add-on seating parts 13 may be provided in FIG. 8.

Meanwhile, the add-on seating part 13 and the add-on device 20 may be provided so as to be coupled to each other only in a specific direction, and at least one switch trigger 15 provided in the add-on seating part 13 may differ from each other in a combination of their location or number.

That is, when a user couples the add-on device 20 to the add-on seating part 13, a combination of the switches 29 that are pressed may differ for each add-on seating part 13.

Thus, when the add-on device 20 is coupled to any one of the add-on seating parts 13 provided in the toy 10, the control circuit unit 25 may transmit information on a combination of pressed switches 29 to the augmented reality contents providing 1 through the communication unit 22.

Accordingly, the augmented reality contents providing device 1 may identify the part of toy 10 to which the add-on device 20 is coupled to.

Also, contents corresponding to the identification information of the corresponding toy 10, particularly, contents regarding the part to which the add-on device 20 is coupled may be withdrawn to be displayed through the display unit.

For example, when the add-on device 20 is attached to the arm of a robot toy as shown in FIG. 8, the augmented reality contents providing device 1 may overlay and display a graphic image of a weapon such as a knife or a gun around the arm part of the robot toy image displayed on the screen.

In this case, when the button 27 of the add-on device 20 is pressed, an animation of swinging a knife or shooting a gun may be played.

On the other hand, when the add-on device 20 is coupled to the body or leg, appropriate contents related to the corresponding part may be similarly withdrawn to be displayed on the screen of the display unit.

In the above description, although the add-on device 20 is illustrated as an electronic device including the communication unit 22 and the sensor 23 and the toy 10 is illustrated as a tool used when a user performs play activities, in an actual embodiment, these may not be clearly distinguished at least in terms of appearance.

That is, the add-on device 20 may also be a toy or a form of plaything, and the toy 10 may be another plaything.

For example, the toy 10 may be a robot toy, and the add-on device 20 may be manufactured into a form of weapon or gear that is attachable to the robot toy.

Although the present invention has been described with reference to the accompanying drawings and the above embodiments, those skilled in the art will appreciate that various modifications and other equivalent embodiments are possible from the above embodiments. Therefore, the scope of the present invention should be defined by the technical spirit of the accompanying claims.

1.-9. (canceled)

10. A toy attachable augmented reality controller coupled to a toy comprising identification information, the controller comprising an add-on device comprising:
an add-on housing;
a communication unit mounted in the add-on housing and communicating with an augmented reality contents providing device by a wired/wireless communication method;
a sensor mounted in the add-on housing and detecting at least one of gravity, acceleration, slope and movement direction which are applied to the add-on housing; and
a control circuit unit reading out the identification information of the toy from the toy as the add-on housing is coupled to the toy and transmitting the identification information of the toy to the augmented reality contents providing device through the communication unit in addition to a value detected by the sensor.

11. The toy attachable augmented reality controller of claim 10, wherein the control circuit unit reads out identification information of the add-on device, and further transmits the identification information of the add-on device to the augmented reality contents providing device instead of or in addition to the identification information of the toy.

12. The toy attachable augmented reality controller of claim 10, wherein the control circuit unit checks information on a part to which the toy is coupled among a plurality of coupling parts of the add-on housing to which the toy is coupled, and
the control circuit unit reads out the identification information of the toy coupled to the corresponding part and transmits a combination of the information on the coupling part and the identification information of the toy to the augmented reality contents providing device instead of or in addition to the identification information of the toy.

13. The toy attachable augmented reality controller of claim 10, wherein the control circuit unit acquires information on a part where the add-on housing is coupled to the toy from the toy as the add-on housing is coupled to the toy, and further transmits the information on the coupling part to the toy attachable augmented reality controller.

14. The toy attachable augmented reality controller of claim 13, wherein the control circuit unit comprises two or more switches on the coupling part with the toy, and acquires information on the coupling part of the toy by a combination of switches pressed by switch triggers on the coupling part of the toy.

15. The toy attachable augmented reality controller of claim 13, wherein when the sensor detects a certain value, the control circuit unit combines at least one of the detected value, the identification information of the toy, information on the part coupled with the toy, and the identification information of the add-on device to transmit to the augmented reality contents providing device.

16. The toy attachable augmented reality controller of claim 10, wherein when the toy is a motion toy, the control circuit unit reads out a toy operation signal of the toy from the toy, and further transmits the toy operation signal of the toy to the augmented reality contents providing device.

17. The toy attachable augmented reality controller of claim 10, wherein when the toy is a motion toy, the control circuit unit receives a control command corresponding to the identification information of the toy from the augmented reality contents providing device, and applies the control command to the toy.

18. A toy attachable augmented reality controller, the controller comprising:
a toy comprising:
a toy housing;
an identification information storing unit mounted in the toy housing and storing identification information of the toy that is digital data;
an add-on seating part formed at an outer side of the toy housing and coupled to the add-on housing; and
a connector comprising a terminal exposed inside the add-on seating part and electrically connecting a connection terminal of the add-on housing and the identification information storing unit as the add-on housing is coupled to the add-on seating part, and
an add-on device comprising:
an add-on housing;
a communication unit mounted in the add-on housing and communicating with a remote device by a wired/wireless communication method;
a sensor mounted in the add-on housing and detecting at least one of gravity, acceleration, slope and movement direction which are applied to the add-on housing; and
a control circuit unit reading out the identification information of the toy from the identification information storing unit of the toy as the add-on housing is coupled to the add-on seating part of the toy and transmitting the identification information of the toy and a value detected by the sensor to the remote device through the communication unit.

19. A toy attachable augmented reality controller comprising a toy coupled to an add-on device comprising: an add-on housing; a communication unit mounted in the add-on housing and communicating with a remote device by a wired/wireless communication method; a sensor mounted in the add-on housing and detecting at least one of gravity, acceleration, slope and movement direction which are applied to the add-on housing; and a control circuit unit reading out the identification information of the toy from the identification information storing unit of the toy as the add-on housing is coupled to the add-on seating part of the toy and transmitting the identification information of the toy and a value detected by the sensor to the remote device through the communication unit,
wherein the toy comprises:
a toy housing;
an identification information storing unit mounted in the toy housing and storing identification information of the toy that is digital data; and
an add-on seating part formed at an outer side of the toy housing and coupled to the add-on housing.

20. The toy attachable augmented reality controller of claim 19, wherein the toy further comprises a connector comprising a terminal exposed inside the add-on seating part and electrically connecting a connection terminal of the add-on housing and the identification information storing unit as the add-on housing is coupled to the add-on seating part.

21. The toy attachable augmented reality controller of claim 19, wherein the identification information storing unit comprises at least one of digital data representing a type of the toy, digital data representing a motion type of the toy, and an unique identifier of the toy.

22. The toy attachable augmented reality controller of claim 19, wherein the toy further comprises:
a toy operating unit comprising at least one of a motor, a speaker and a light emitting unit and controlling the motion of the toy through the motor, the speaker or the light emitting unit, generating a sound or emitting light; and
a toy operation signal transmitting/receiving unit transmitting a toy operation signal to the add-on device coupled to the add-on seating part through the connector when there is a motion of the toy by the toy operating unit.

23. A toy attachable augmented reality controller comprising a toy coupled to an add-on device comprising: an add-on housing; a communication unit mounted in the add-on housing and communicating with a remote device by a wired/wireless communication method; a sensor mounted in the add-on housing and detecting at least one of gravity, acceleration, slope and movement direction which are applied to the add-on housing; a plurality of switches exposed on one side surface of the add-on housing and generating a signal when being pressed or contacted; and a control circuit unit transmitting a value detected by the sensor to the remote device through the communication unit, wherein when the add-on housing is coupled to the add-on seating part of the toy, at least a portion of the plurality of switches is pressed or contacted by a switch trigger of the toy, and the control circuit unit transmits information on a combination of switches generating a signal among the plurality of switches to the remote device through the communication unit,
wherein the toy comprises:
a toy housing;
an add-on seating part formed at an outer side of the toy housing and coupled to the add-on housing; and
at least one switch trigger protruded or recessed at one side of the add-on seating part.

24. The toy attachable augmented reality controller of claim 23, wherein the at least one switch trigger represents identification information of the toy by the location and combination of the at least one switch trigger.

25. The toy attachable augmented reality controller of claim 23, wherein the toy comprises a plurality of add-on seating parts, and
at least one switch trigger provided in each add-on seating part differs from each other in a combination of location or number thereof.
